(19) United States
(12) Patent Application Publication
(10) Pub. No.: US 2017/0203942 A1
(43) Pub. Date: Jul. 20, 2017

(54) Device and method for preventing or reducing the flattening of one or more wheels of a vehicle

(71) Applicant: Butler Engineering and Marketing S.p.A., Rolo (Reggio Emilia) (IT)

(72) Inventors: Tullio Gonzaga, Correggio (Reggio Emilia) (IT); Silvano Santi, Imola (Bologna) (IT)

(73) Assignee: Butler Engineering and Marketing S.p.A., Rolo (Reggio Emilia) (IT)

(21) Appl. No.: 15/326,795

(22) PCT Filed: Jul. 14, 2015
(86) PCT No.: PCT/IB2015/055317

§ 371 Date: Jan. 17, 2017

(30) Foreign Application Priority Data
Jul. 16, 2014 (IT) VR2014A000183

(51) Int. Cl. B66F 7/24; B60B 30/02; B66F 3/35

(52) U.S. Cl. CPC B66F 7/243; B66F 3/35; B60B 30/02; G05D 16/04

(57) ABSTRACT

The present invention relates to a device for preventing or reducing the flattening of the tire (T) of a wheel (TW) of a vehicle (MV) during a parking period, the device including an abutment surface configured or configurable as a lower portion (LP) of the tread of a tire of a tired wheel (TW) and such to apply to the lower portion (LP) and over the entire extension thereof a substantially uniform pressure.

### TECHNICAL FIELD OF THE INVENTION

The present invention relates to a device for preventing or reducing the flattening of the tire of one or more wheels of a vehicle, in particular during a period of stopping or parking thereof, as well as a method for preventing or reducing the aforesaid flattening.

### STATE OF THE PRIOR ART

Vehicles, in particular motor vehicles, are often left parked or stopped by their respective owners, sometimes for a long time, e.g. during vacation periods.

In such situation, the wheels of the vehicle, in particular a lower portion of the tread of the tire thereof, is not uniformly stressed over the entire extension thereof, which causes a substantial flattening of the lower portions of the wheels; such flattening is a function of the weight resting on the wheels as well as of the inflation pressure of the latter.

Such flattening, in particular for long stopping or parking periods, can become permanent and cannot be eliminated, not even by using or driving the vehicle for some time, so that, in such cases, it may be necessary to substitute the wheels or the flattened tires.

In order to prevent such drawback, often, before prolonged parking or stopping periods, the tires are inflated to a pressure greater than the normal or regular use pressure, sometimes even to a pressure double that of the normal use pressure. If on one hand such solution does not completely eliminate the problem, since a minimum flattening is still verified, on the other hand it determines excessive stress for the tires.

According to another solution in accordance with the state of the art, the vehicle is placed on supports intended to keep it raised, such that the wheels do not come into contact with the ground. This, as verified, involves considerable mechanical stress for the vehicle suspensions, which sustain loads opposite those of normal use and can be damaged.

### SUMMARY OF THE INVENTION

The main object of the present invention is to provide a new device for preventing or reducing the flattening of the tire of a wheel of a vehicle during a period of parking or stopping thereof.

Another object of the present invention is to avoid the abovementioned drawbacks with a device that is easy to use and very quick and effective.

Another object of the present invention is to provide a new method for preventing or reducing the flattening of the tire of a wheel of a vehicle during a period of parking or stopping thereof.

Another object of the present invention is to provide a new method as stated above that is simple and quick to obtain.

In accordance with one aspect of the invention, a device is provided according to the present specification.

In accordance with one aspect of the invention, a method is provided according to the present specification.

The present application refers to preferred and advantageous embodiments of the invention.

### BRIEF DESCRIPTION OF THE DRAWINGS

Other characteristics and advantages of the invention will be clearer from the description of embodiments of devices for preventing or reducing the flattening of a wheel of a vehicle, illustrated by way of example in the enclosed drawings, in which:

FIGS. 1 and 2 are respectively side and perspective views of a wheel of a parked vehicle according to the state of the art;

FIGS. 3 and 4 are views similar to FIGS. 1 and 2 in accordance with another embodiment according to the state of the art;

FIGS. 5 and 6 are respectively side and perspective views of a wheel of a parked vehicle placed on a device according to the present invention;

FIG. 7 is a front view of a wheel of a parked vehicle placed on a device according to the present invention;

FIGS. 8 and 9 are respectively side and front views of the device of FIGS. 5, 6 and 7 in work position;

FIGS. 10 and 11 are respectively side and front views of the device of FIGS. 5, 6 and 7 in work position, in which, for illustration clarity, the wheel is illustrated separated from the device;

FIGS. 12 and 13 are views similar to figure of respective alternative device embodiments according to the present invention;

FIGS. 14 and 15 are views similar to FIGS. 5 and 6, but relative to another device embodiment according to the present invention;

FIGS. 16 and 17 are side views of another device embodiment according to the present invention, respectively on its own and supporting a respective wheel;

FIG. 18 is a side view of a parked vehicle according to the present invention and including devices according to figures from 5 to 17;

FIGS. 19 and 20 are side views of a wheel of a vehicle on top of a device according to the present invention in respective operative positions; and

FIG. 21 is a view of a wheel on another device embodiment according to the present invention.

In the set of drawings, equivalent parts or components are marked with the same reference numbers.

### DESCRIPTION OF THE ILLUSTRATED STATE OF THE ART

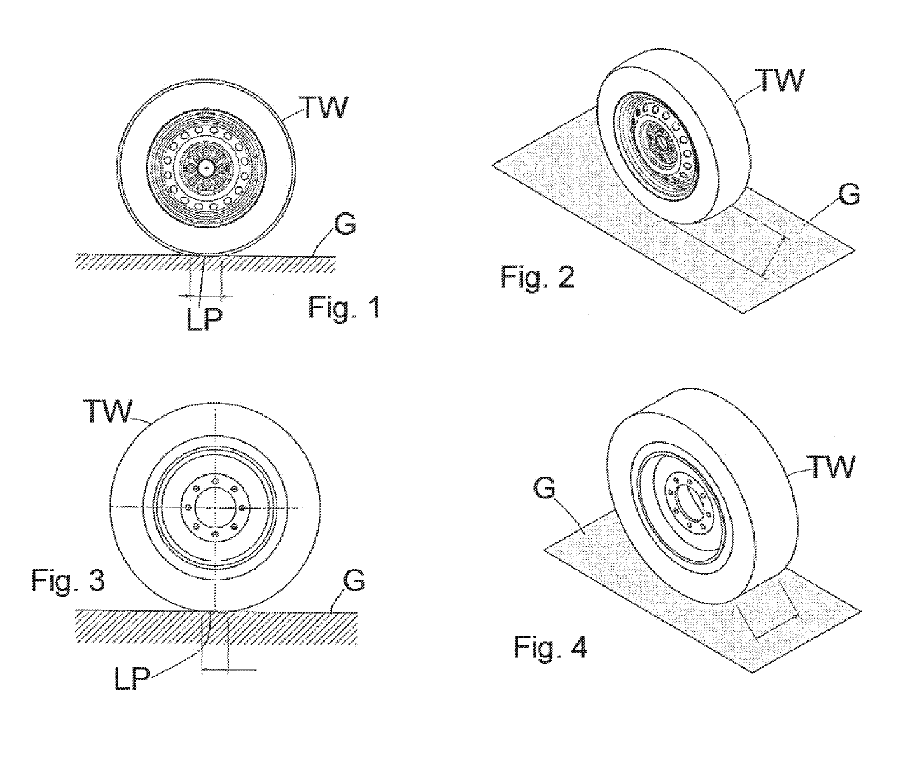

With reference to FIGS. 1 and 2, a wheel TW of a parked or stopped vehicle or motor vehicle is illustrated; such wheel TW has a lower portion LP of the tread of the tire thereof, set on the ground G, substantially flattened. Assuming that the wheel TW has been inflated to about 2 Bar and the vehicle subjects the wheel TW to a weight of about 400 Kg, the flattened lower portion LP would have a surface area of about 200 cm², obtainable from the following equation: 400 kg/2 bar=200 cm².

In FIGS. 3 and 4, a wheel TW is instead illustrated, e.g. of a truck or bus; such wheel is inflated to about 8 bar and subject to a weight of about 3120 Kg; in such case, the flattened lower portion LP would be about 390 cm² (3120 kg/8 bar=390 cm²).

### DETAILED DESCRIPTION OF EMBODIMENTS OF THE INVENTION

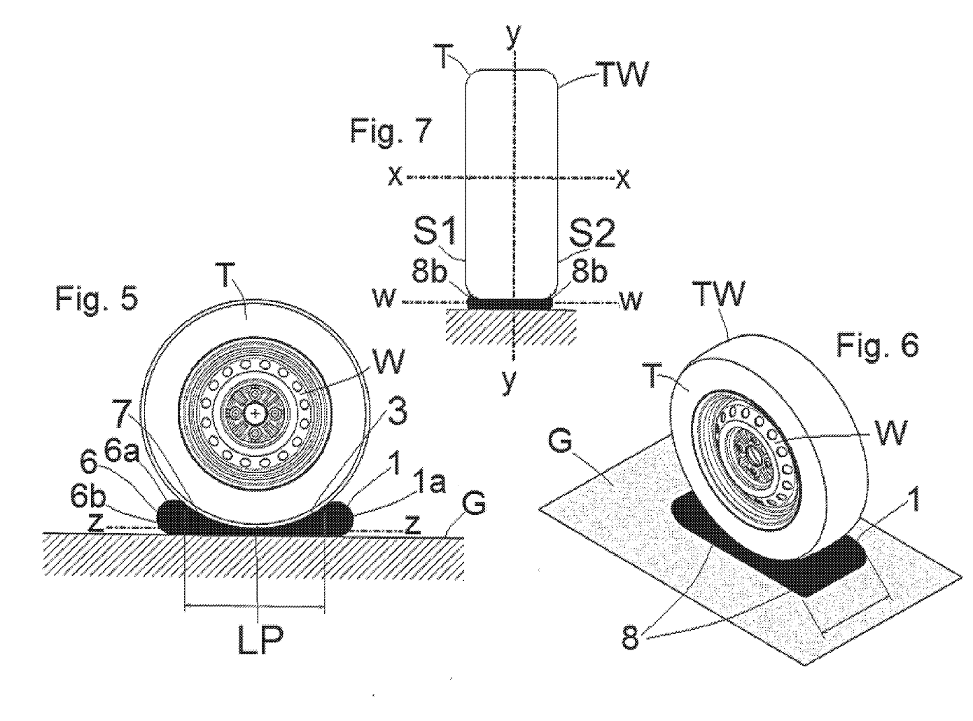

Referring now to FIGS. 5 to 13, a device 1 according to the present invention is illustrated for preventing or reducing the flattening of the tire T of a wheel TW of a vehicle, during a period of parking or stopping thereof. The wheel TW of the vehicle is naturally arranged in elevated or vertical position, i.e. with rotation axis x-x substantially horizontal. The wheel TW naturally comprises a tire T mounted on a rim W, and both the tire T and the rim W are substantially mounted coaxial around the axis x-x.

The device comprises an abutment surface 3 configured or configurable as a portion LP, lower during use, of the tread of the tire T of the wheel TW and such to apply to such lower portion and over the entire extension thereof, hence over the entire length and entire width thereof, a substantially uniform pressure so as to prevent or reduce the flattening of the wheel TW during the parking or stopping period.

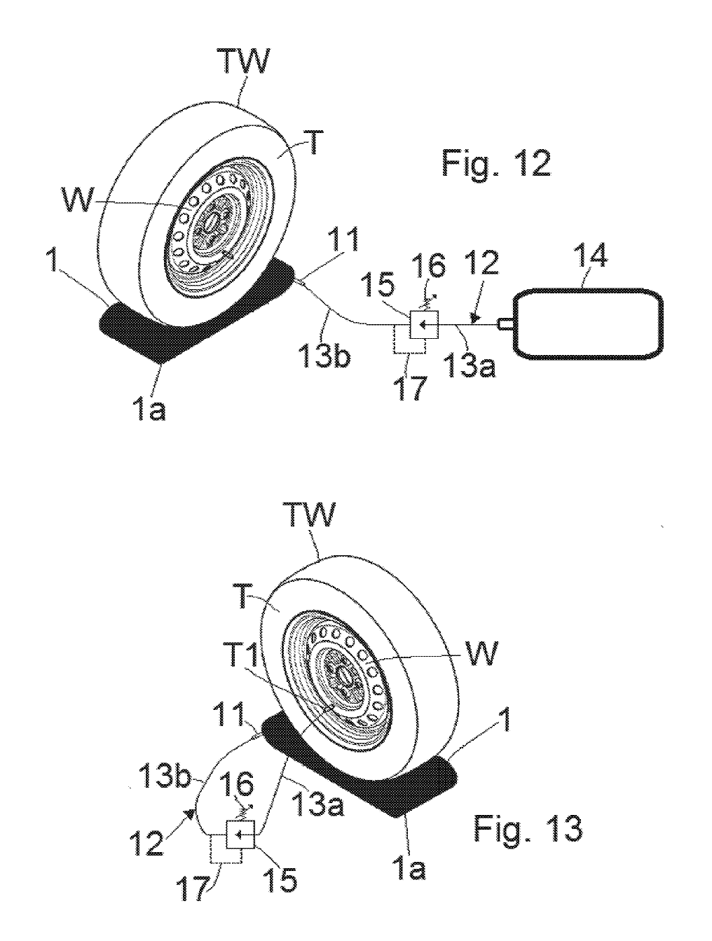

Advantageously, the device comprises a cushion component or container 1a that can be inflated or filled, having at least one valve or one connector 11 (see in particular FIGS. 12 and 13) for feeding or evacuating a gas, such as pressurized air, or a liquid into or from the container.

For such purpose, with reference in particular to FIGS. 12 and 13, a device according to the present invention comprises means for self-regulating 12 the fill level or the pressure of the gas and/or liquid at its interior, intended to automatically restore, i.e. without the intervention of an operator, the pressure of the gas and/or liquid in the container 1a if the same should fall below a threshold value.

Such self-regulating means 12 comprise, for example, a feed line, if desired comprising two tube sections 13a, 13b. Such line is on one side connected, in particular sealingly connected, to the connector or to the valve 11 and on the other side connected, in particular sealingly connected, with a tank of gas and/or liquid, such as a bomb 14 (see FIG. 12), e.g. full of gas, if desired CO₂, or with the tire T supported by the container 1a or better yet with the valve T1 for filling/emptying such tire (see FIG. 13). The feed line is thus intended to place the container 1a and the tank 14, T in fluid communication.

Advantageously, the self-regulating means 12 then comprise at least one pressure regulator 15, e.g. a pressure reducer, which intercepts the feed line 13a, 13b and is intended to receive, in inlet, the fluid from the tank 14, T of gas and/or liquid at an inlet pressure, mainly established by the tank, and to deliver it to an adjusted or adjustable outlet pressure.

According to the embodiment illustrated in the figure, there is therefore a first tube section 13a of the feed line connected to a tank of gas and/or liquid (bomb 14 or tire T), a second tube section 13b of the feed line connected to the connector or valve 11 and a pressure regulator 15 actually placed for the fluid connection and communication between the two tube sections 13a, 13b.

If desired, the pressure regulator 15 can have adjustable outlet pressure. For such purpose, adjusting means can be provided, such as a thrust or traction element 16, e.g. an elastic loading element or a pneumatic component, acting on the one side of the pressure regulator 15; such thrust or traction element 16 has adjustable force or action, in the sense that it is possible to increase/decrease, in controlled manner, the thrust or traction force exerted thereby on the pressure regulator 15. Hence, in such case, a branch duct 17 can also be provided that is extended between the feed line 13a, 13b and the pressure regulator 15 and intended to operate on the pressure regulator 15, so as to vary the outlet pressure, in particular by feeding liquid or gas towards a respective chamber or side of the regulator 15, if desired opposing the thrust or traction element 16, whether the latter has fixed or adjustable action. More particularly, according to the illustrated embodiment, the branch duct 17 is extended between the second tube section 13b and the pressure regulator 15, if desired between the second tube section 13b and a second side of the pressure regulator 15 opposite the first operation side of a thrust element 16 or corresponding to the operation side of a traction element.

As an alternative to or in combination with the above-described expedients, as will be understood, sensor means could be provided that are intended to detect the pressure or the fill level in the container 1a or the distance from the ground of a wheel TW placed on the container 1a, as well as an electronic or pneumatic controller in communication with the sensor means and intended to adjust (increase/decrease) the delivery of liquid or gas towards the container 1a as a function of the detection made by the sensor means. For such purpose, the controller could be movable between an open position of the feed line 13a, 13b and a closed position of the feed line 13a-13b as a function of the detection made by the sensor means.

Moreover, the electronic or pneumatic controller could operate on the regulator 15 or, if provided, on the adjusting means 16.

Furthermore, the pressure regulator 15 might not even be provided; rather, the container 1a of the device 1 could be connected with a tank and a suitable electronic or pneumatic controller could be set to open/close the fluid communication therebetween as a function of the filling or pressure of gas/liquid in the container 1a or of the distance of a respective wheel TW (i.e. a wheel TW placed on the device) from the ground.

In such case, once the device 1 is inflated as desired, it is connected or maintained connected to a tank (bomb 14 or tire T) by means of a feed line 13a, 13b, if desired intercepted by a pressure regulator 15. If the pressure in the device 1 should fall, the self-regulating means 12 would open or increase the fluid communication between the container and the tank, thus restoring the pressure or desired fill of the container. According to the embodiment illustrated in FIGS. 12 and 13, this would occur since, due to the fall of pressure in the device 1, the pressure in the branch duct 17 would be consequently reduced and hence the action of the loading/thrust or traction element 16 would overcome the action of the fluid transported by the branch duct 17, opening or increasing the passage section through the pressure regulator 15. This would determine an increase of the flow or better yet of the pressure of the gas/liquid from the tank (bomb 14 or tire T) to the device 1, until the desired pressure in the latter has been restored, when the pressure in the branch duct 17 would be such to suitably oppose the action of the loading/thrust or traction element 16 and hence close or bring the pressure regulator 15 back to the preceding condition.

With regard to the variant of FIG. 13, such solution can be achieved and is functional since the volume and the pressure necessary inside the device 1 are much less than the volume and pressure inside the tire T.

The embodiments illustrated in FIGS. 12 and 13, as will be understood, ensure a suitable filling of the device that is actually self-regulated, without it being necessary to periodically control and possibly restore the pressure or the fill level of the fluid (liquid/gas) in the container 1a of the device 1.

Hence, due to the above-described expedients, it is possible to regulate the pressure inside the container of the device 1, also as a function of the weight of the wheel to be raised, obtainable in particular by setting the outlet pressure from pressure regulator to the desired value, by operating on the adjusting means 16.

Still more advantageously, a device according to the present invention comprises a fluid-sealed container filled or inflated with a gas and/or with a liquid.

More particularly, the abutment surface of a device 1 according to the present invention comprises, preferably, at least one surface 3, upper during use, that can be deformed as a function of the weight applied thereto by a respective wheel TW and thus to be deformed and adapted to a lower portion LP of the tread of the tire T of the wheel TW.

More particularly, the container can comprise a shell externally delimiting an external face, which on the upper part delimits the surface 3 engageable by a wheel TW of a vehicle as well as an internal face delimiting the internal fluid-sealed zone of the container, into which/from which a gas and/or a liquid can be fed/evacuated. Preferably, the shell has a thickness substantially constant between 1 and 2 mm.

Advantageously, the container 1a comprises a first wall or base wall 4 intended to be set on a support surface, such as the ground G, a second wall or top wall 5 intended to come into contact with a tired wheel TW of a vehicle and an edge wall 6, if desired substantially curved and with concavity directed towards the interior of the container 1a, the edge wall 6 extended between and sealingly connecting the first wall 4 and the second wall 5. The top wall 5 delimits outside the container and towards the top the abutment surface 3.

The edge wall 6 actually comprises a tubular side wall, which is extended between the entire perimeter of the first wall 4 and the entire perimeter of the second wall 5.

Still more advantageously, the container has a fluid-sealed body configured as a geometric solid, if desired around a symmetry axis y-y, with the first wall or base wall 4 being substantially flat or slightly curved and with cross section slightly increasing in moving close to the edge wall 6.

The edge wall 6 can instead be tubular, e.g. substantially curved, and have a first tubular section 6a, lower during use, if desired with cross section increasing in moving away from the first wall 4, and then a second tubular section 6b, upper during use, if desired with cross section decreasing in moving close to the second wall 5. The second wall 5, finally, can be substantially flat or slightly curved with cross section slightly decreasing in moving away from the edge wall 6.

The container of the device can be obtained in a single piece with fluid seal, or comprise two or more plates welded together with fluid seal, such that the gas or the liquid can exit or be eliminated from the container or from the respective fluid-sealed internal zone only through one or more suitable valves.

The first section 6a and the second section 6b of the edge wall 6 are formed in a single piece or by means of two plates sealingly welded together in a manner so as to form a continuous tubular portion (i.e. without interruptions), e.g. curved with substantially constant curvature radius.

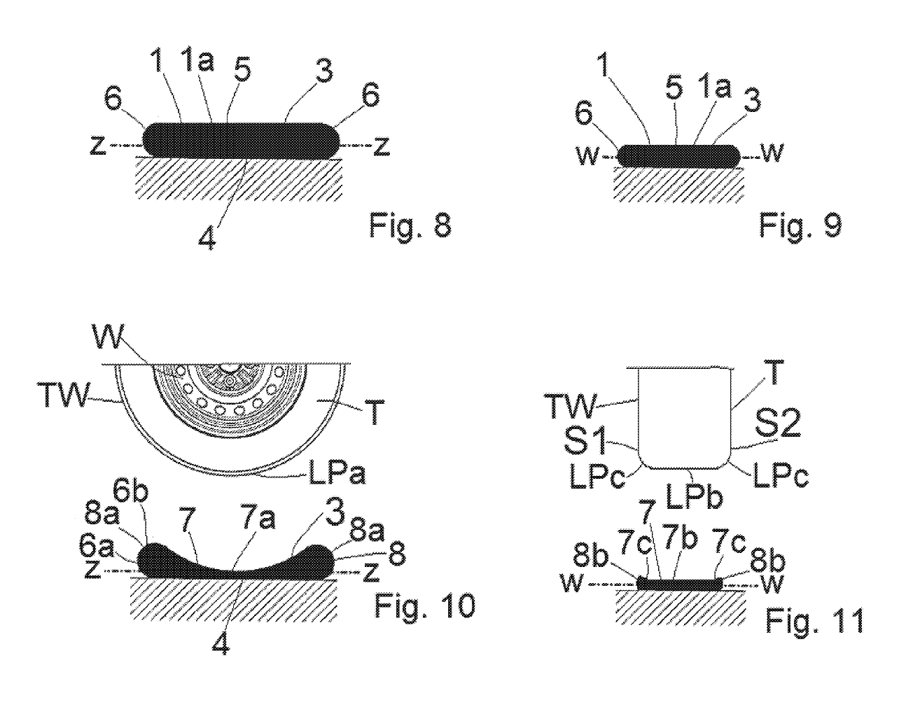

The second wall or top wall 5 can be deformed due to the weight of a tired wheel TW placed thereon (if the wheel is brought on top of a device already inflated) or in order to be adapted to the configuration of the lower portion LP and support the weight of a tired wheel (if the wheel is brought on top of a device that is deflated and then the device is inflated), between a rest position, in which the device is deflated or the same is inflated (see FIGS. 8 and 9), in which case the second wall 5 can be substantially flat or slightly curved, e.g. with concavity directed downward, and a work or inflation position (see FIGS. 5, 6, 7, 10 and 11) in which the second wall 5 is deformed (as a function of the weight of the wheel TW and of the configuration of the lower portion LP thereof or in order to be adapted to the configuration of the lower portion LP and support the weight of a respective tired wheel TW) so as to delimit a curved seat or depression 7, e.g. substantially central, which has a concavity directed upward and has a shape substantially complementary to a lower portion LP of the tread of the tire T of the tired wheel.

Preferably, in the work position, the curved seat or depression constitutes an intermediate zone 7 that is lowered and proximal to the first wall 4 around which an enlarged peripheral zone 8 is arranged, i.e. with upper surface—upper during use—distal from the first wall 4 with respect to the intermediate zone 7. Still more preferably, the depression or seat 7 is fully enclosed, or at least at and outside the smaller sides of the same within an area delimited by the peripheral zone 8, i.e. that the peripheral zone 8 is extended all around the intermediate zone 7 or around the smaller sides of the intermediate zone 7.

In such case, the peripheral zone 8 has two first sections 8a that are substantially parallel, preferably smaller and enclosing or placed around the smaller sides of the intermediate zone 7. The peripheral zone 8 can, if desired, also comprise two substantially parallel second sections 8b, preferably larger and each extended as a bridge from one end of one smaller section 8a to one end of the other smaller section 8a, and each enclosing or placed around the greater sides of the intermediate zone 7.

More particularly, the intermediate zone 7 has a length and a width, by length it being intended the extension of the intermediate zone 7 along a first extension axis or longitudinal extension axis z-z of the device, while by width it is intended the extension of the intermediate zone 7 along a second extension axis w-w (during use substantially parallel to the rotation axis x-x of the wheel to be supported) transverse or orthogonal to the first extension axis z-z. The intermediate zone 7, in the work position, has a substantially circular profile 7a in section taken along a first vertical plane passing through the first extension axis or longitudinal extension axis z-z, or in section taken along a plane parallel to such first vertical plane.

The substantially circular profile 7a has concavity directed upward during use and has a distance from the first wall 4 increasing from the center towards the exterior of the intermediate zone 7. The substantially circular profile 7a is extended for the entire width of the intermediate zone 7, so as to configure a band with substantially circular profile. The band with substantially circular profile is complementary or corresponds in substance to the curved profile LPa of the lower portion LP of the tread of the tire T of the wheel supported by the vehicle in the direction orthogonal to the rotation axis of the wheel TW itself, which corresponds, in substance, to the rolling advancement direction, during use, of the wheel TW. More particularly, the substantially circular profile or profile with circumference section 7a is extended around a center that lies, during use, on the rotation axis x-x of the wheel TW supported by the container 1a.

Preferably, the intermediate zone 7 in section taken along a second vertical plane passing through the second extension axis w-w, or in section taken along a plane parallel to such second vertical plane, is substantially flat 7b at the center and for the entire or for most of the extension thereof, about 70%-90% of the extension thereof. Still more preferably, the intermediate zone 7 has substantially flat cross section 7b for the entire length thereof.

If desired, the intermediate zone 7, still in section taken along a second vertical plane passing through the second extension axis w-w or in section taken along a plane parallel to such second vertical plane, can have slightly curved external connector portions 7c with the peripheral zone 8 or better yet with possible two second sections 8a of the same, the curved external portions 7c therefore having a distance from the first wall 4 which increases in the direction moving away from the substantially flat portion 7b.

The substantially flat portion 7b of the intermediate zone 7 in practice is complementary to the profile of the transverse portion of the tread of the tire of the wheel TW, which in optimal inflation condition of the tire T fit on the wheel, or better yet on the rim thereof, is substantially rectilinear LPb. The curved external portions 7c of the intermediate zone 7, if provided, instead correspond in substance to the profile or part of the connector sections LPc of the curved portion LPa and of the substantially rectilinear profile LPb of the tread with the sidewalls S1 and S2 of the tire of the tired wheel TW.

The two first sections 8a of the peripheral zone 8 are extended substantially parallel to the second extension axis w-w, while the two second sections 8b of the peripheral zone 8, if provided, are instead extended substantially parallel to the first extension axis z-z.

Preferably, in the passage, due to the weight of a tired wheel TW or in order to be adapted to the lower portion of the tired wheel TW, from the rest position to the work position, part of the fluid contained in the container 1a flows, if desired (in particular when the wheel is brought on top of a deflated device and then the device is inflated) also from a portion of the container affected or pressed by the wheel, towards the sides or in any case the edge thereof.

In such a manner, the aforesaid intermediate zone 7 is determined or generated, which represents the zone, during use, subjected to the weight of the wheel and at which or better yet under which the fluid in the device flows or is controlled to flow away when a wheel is placed or made to roll on top of the container 1a, as well as (giving rise to) the peripheral zone 8 which represents the zone in which most of the fluid is actually conveyed, such fluid exiting or thrust away from the area of the device below the intermediate zone 7.

Due to this, the intermediate zone 7 will be substantially complementary to and in contact with the entire extension of a lower portion LP of the tread of the tire of a respective wheel to be supported, both in the direction of a first extension axis z-z (length) of the device, and in the direction of a second extension axis w-w (width) of the device orthogonal to the first axis z-z and substantially parallel to the rotation axis x-x of the respective wheel TW to be supported.

The peripheral zone 8 is instead intended to partly or fully wind around the lower portion of the tread.

If desired, when the container 1a is placed under a wheel of a vehicle, the intermediate zone 7 or better yet the more central and hollow or recessed part thereof, can also be at a distance of about 1-2 mm from the first wall 4.

For such purpose, the main object of the present invention is to provide a uniform support of a lower portion of the wheel, therefore it is no longer necessary to significantly lift the same from the ground, but a minimum separation of the wheel from the ground will suffice.

The container can for example be made of a material selected from the group comprising rubber reinforced with canvas or plasticized canvas or comprise an envelope or air chamber made of rubber coated with a strong but flexible layer or sock, e.g. made of canvas or another suitable material.

Hence, the container can be made of elastic material, such that the same can be deformed upon insertion of the gas and/or liquid therein, so as to be suitably shaped with respect to the profile of a wheel TW situated thereon.

If however a wheel is rolled above the already-inflated container, the possible elasticity of the shell of the container would ensure the suitable adaptation of the container to the profile of the lower portion of the wheel TW as well as the return into rest position of the container once the vehicle, and then the wheel is descended or brought outside the intermediate zone of the container.

With a device according to FIGS. 5 to 11, it is possible to support a wheel for a zone 7 of about 800 cm² and therefore a wheel of a vehicle inflated to 0.5 bar, on which a weight of 400 kg by the respective vehicle is applied, without deforming the wheel or better yet the lower portion LP thereof which therefore remains substantially round.

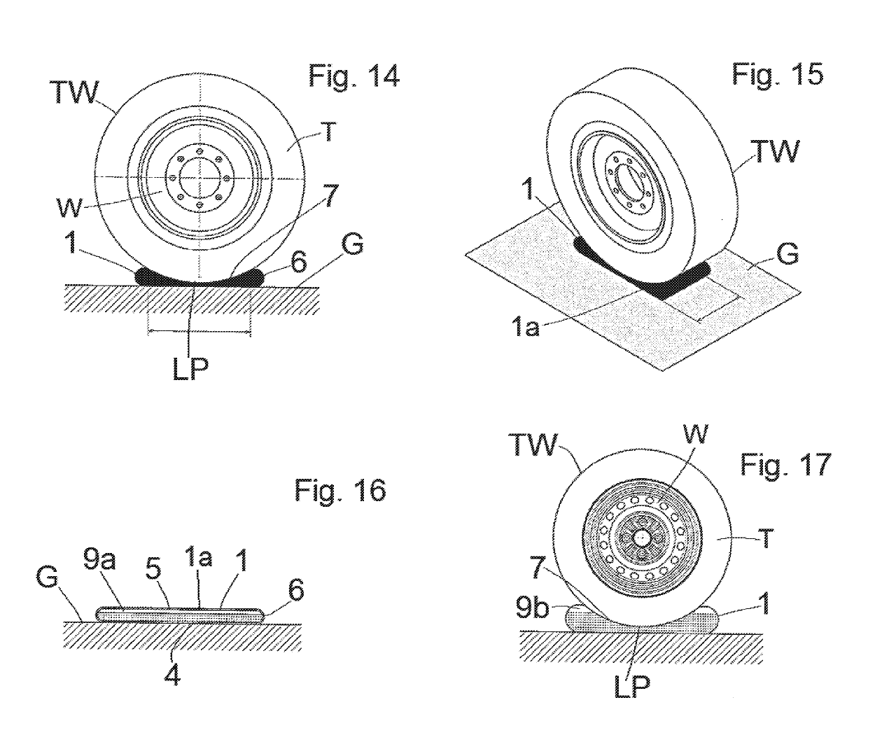

In FIGS. 14 and 15, instead, a device is illustrated that is similar to that of FIGS. 5 to 13, but for the support of a truck wheel and capable of providing an abutment surface of about 1500 cm², such that it is possible to sustain a wheel inflated to about 2 bar and subjected to a weight of 3000 kg.

With regard then to FIGS. 16 and 17, these illustrate a device entirely similar to that illustrated in FIGS. 14 and 15, but entirely or partially filled with liquid.

In such case, the device is preferably obtained by means of a shell made of elastic material.

The container when filled or fillable with liquid, then the same could be entirely full or fully fillable with liquid, or, alternatively, in order to obtain a correct distribution of the pressure therein, so as to apply, as stated above, a substantially uniform pressure to a lower portion of a overlying wheel, an interspace or chamber 9a filled with gas is left in the container, e.g. air is left in the container, which in rest position constitutes a layer of gas above the liquid. When a wheel TW is made to roll on top of the container filled with liquid, then the gas in the interspace 9a is actually compressed, for example in an annular chamber or in sectors 9b delimited inside and in upper zones of the container, thus obtaining a correct distribution of the pressure in the container as well as the return into initial position of the container when the wheel is made to roll away.

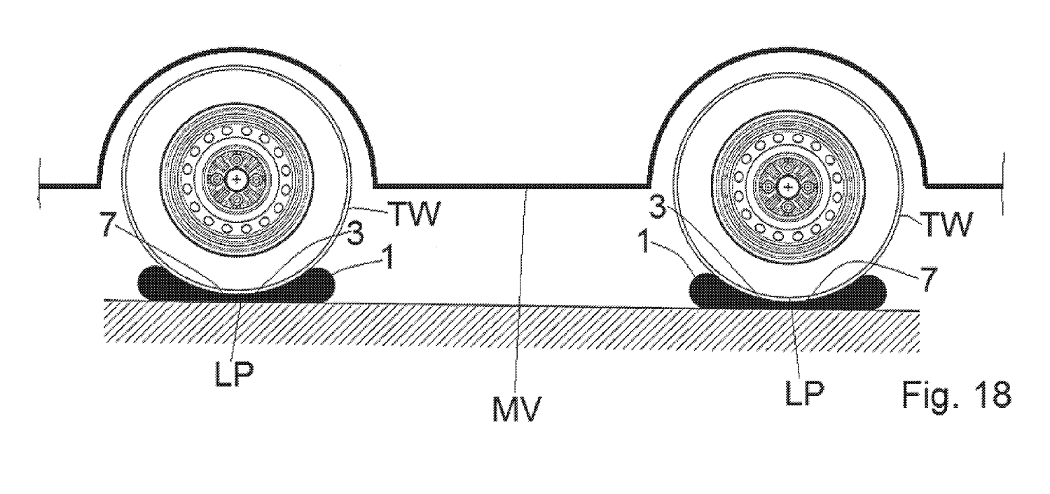

With reference now to FIG. 18, a vehicle is instead illustrated that is if desired motorized MV, e.g. a motor vehicle or automobile, having a frame (not illustrated in the figure) slidably mounted and supported on a plurality of wheels TW, e.g. four, six or eight wheels TW, which is parked and has one or more devices 1 like the aforesaid arranged under the wheels TW thereof. One or more of the wheels has/have a respective lower portion LP of the tread of the tire T thereof complementary with, entirely housed in and supported by an abutment surface 3 of a respective device 1, so as to prevent or reduce the flattening of the lower portion of one or more wheels of the parked vehicle. Preferably, multiple devices are provided for, e.g. four, six or eight, each below and supporting a respective wheel of the vehicle. As will be understood, a vehicle according to the present invention can comprise devices as described above, as well as devices according to the embodiments described hereinbelow.

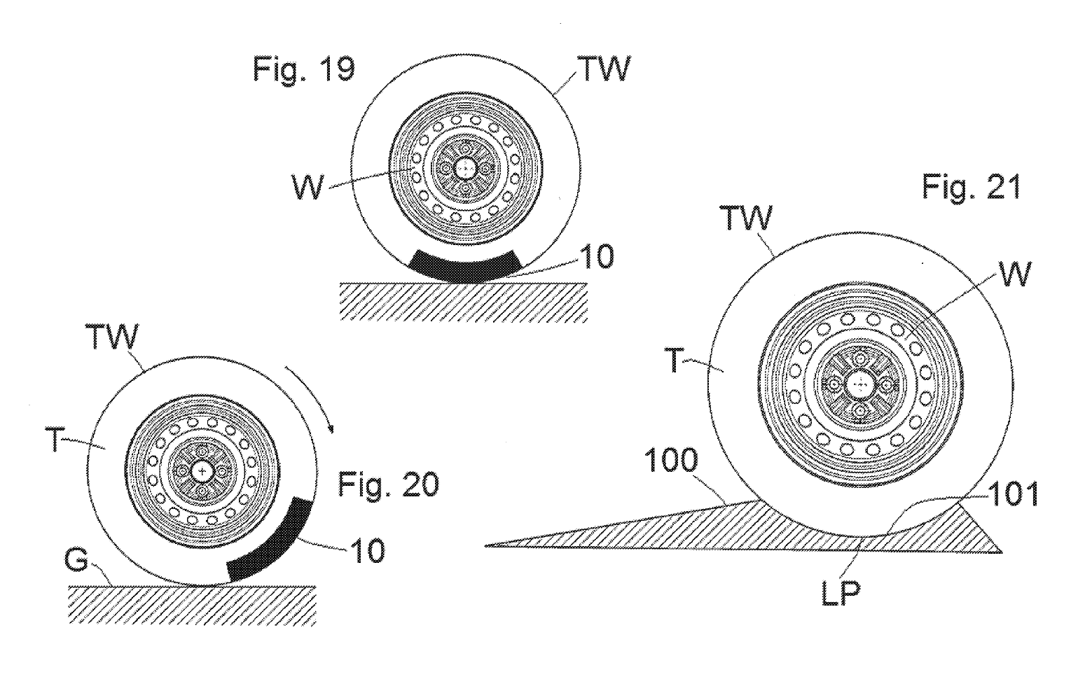

With reference now to FIGS. 19 and 20, another device according to the present invention is then illustrated, which comprises a fender component 10 connected to a wheel TW and movable, if desired, by rolling the wheel, between a first rest position (see FIG. 19) and a second position (see FIG. 20) in which it is interposed between the wheel TW and the ground G.

Preferably, the fender component 10 comprises a curved internal face complementary to a portion LP of the tread of the tire T of a wheel TW.

Still more preferably, the fender component 10 comprises a body with substantially U-shaped cross section with a curved intermediate section delimiting the curved internal face and two lateral sections extended from the intermediate section from opposite sides with respect to the intermediate section and each intended to wind around a section of a respective sidewall of a tired wheel.

The fender component 10 can have an internal face which, according to a first extension axis of the device, has a band with substantially circular profile, entirely similar to the portion 7a, which is complementary to or corresponds in substance to the curved profile LPa of the lower portion LP of the tread of the tire of the wheel to be supported of the vehicle, while in accordance with a second extension axis, the internal face has a portion substantially flat at the center and for most of its extension in the direction of the second extension axis, and can then have slightly curved external connector portions, entirely similar to the portions 7c intended to engage connector sections LPc of the curved portion LPa and of the substantially rectilinear profile LPb of a tread of a tire of a tired wheel TW to be supported. In substance, the internal face of a fender component 10 can be configured, for example as described with reference to the intermediate zone 7 of the device 1.

The external face of the fender can instead be configured as the internal face or be substantially flat.

The fender component, if desired, can then comprise means for the removable connection to a wheel, for example screws, bolts, or be mounted or inserted to size on a portion of the tread of a tire of a wheel.

A fender component according to the present invention can be made, for example of metal.

In FIG. 21, another device according to the present invention is then illustrated, which comprises a ramp or abutment component 100 in which at least one slot or depression 101 is formed in which a wheel TW of a vehicle is housable and having profile substantially complementary to a lower portion of the tread of a tire of a wheel.

The slot or depression 101 can be configured or complementary to a lower portion LP of the tread of the tire of a wheel to be supported, the latter being arranged within the slot 101 during parking, so as to not be deformed. The slot or depression 101 can be configured, for example as described with reference to the intermediate zone 7 of the device 1.

A method according to the present invention for preventing or reducing the flattening of a wheel of a vehicle during a period of parking or stopping thereof, therefore provides for:
arranging a device 1, 10, 100 as indicated above;
bringing at least one wheel of the vehicle on top of the or a respective device in a manner such that a lower portion LP of the tread of the tire of the wheel is entirely set on and substantially complementary with an abutment surface of the device and such to apply to the lower portion—lower during use—of the tread and over the entire extension thereof a substantially uniform pressure so as to prevent or reduce the flattening of the wheel during the parking or stopping period.

Preferably, a plurality of devices according to the present invention are arranged, and a lower portion of the tread of the tire of each wheel of the plurality of wheels is set on and complementary with an abutment surface of a respective device, such that it is possible to prevent or reduce the flattening of all the wheels of the parked vehicle.

If a method according to the present invention is carried out by using one or more inflatable devices 1, then one can arrange the device/s 1 that is/are deflated and after having brought one or more wheels thereon, the device/s is/are inflated to as to obtain that a lower portion of the tread of the wheel is entirely set as aforesaid on an abutment surface of the or of a respective device.

Alternatively, the device can be inflated before the movement thereon of one or more wheels of the vehicle to be parked.

As will be understood, a device according to the present invention allows supporting one or better yet all of the wheels of a parked vehicle in a stable and effective manner, preventing or in any case limiting possible flatting of the wheel, and this since the device has an abutment surface that is configured (see an inflated container 1a, the fender component 10 or the ramp component 100) or configurable (see the inflatable container 1) like a curved portion LPa of the tread of a tired wheel.

An abutment surface configured as described above therefore provides a wide zone of support and distribution of the weight of the wheel, which therefore allows preventing localized pressures causing the flattening in the currently used solutions.

In the present text, the tread was considered with a substantially continuous and non-hollow external surface, i.e. not considering the grooves formed in the tread itself; however, there is no insertion of respective parts of the device in such grooves, having also considered the fact that such grooves have a width of several millimeters or in any case quite limited.

Modifications and variants of the invention are possible within the protective scope defined by the claims.

1. A device for preventing or reducing the flattening of the tire of a wheel of a vehicle during a period of parking or stopping thereof, characterized in that it comprises an abutment surface configured or configurable as a lower portion of the tread of a tire of a tired wheel and such to apply to said lower portion, and over the entire extension thereof, a substantially uniform pressure so as to prevent or reduce the flattening of the tire of said wheel during said parking or stopping period.

2. The device according to claim 1, wherein said device comprises an abutment surface configured or configurable as a lower portion of the tread of a tire of a tired wheel, both in the direction of a first extension axis (z-z) of the device, and in the direction of a second extension axis (w-w) of the device orthogonal to said first extension axis (z-z).

3. The device according to claim 1, further comprising an inflatable or inflated container having at least one valve or one connector for feeding or evacuating a gas and/or a liquid into or from said container.

4. The device according to claim 3, further comprising means for self-regulating the fill level or the pressure of the gas and/or liquid inside said container intended to restore the fill level or the pressure of the gas and/or liquid in said container if the fill level or the pressure should fall below a threshold value.

5. The device according to claim 4, further comprising a tank of gas and/or liquid and in that said self-regulating means comprise a feed line on one side connected to said connector or valve and on the other side connected to said tank of gas and/or liquid, such that said feed line is intended to place said container in fluid communication with said tank.

6. The device according to claim 5, wherein said self-regulating means comprise at least one pressure regulator intercepting said feed line and intended to receive, in inlet, gas and/or liquid from said tank at an inlet pressure and to deliver it towards said container at an adjusted or adjustable outlet pressure.

7. The device according to claim 6, wherein said self-regulating means comprise at least one pressure regulator intercepting said feed line and intended to receive, in inlet, gas and/or liquid from said tank at an inlet pressure and to deliver it towards said container at an adjusted or adjustable outlet pressure and wherein said self-regulating means comprise an adjusting means acting on said pressure regulator, said adjustment means having adjustable force or action, i.e. that it is possible to increase or decrease, in a controlled manner, the thrust or traction force or action exerted thereby on said pressure regulator, so as to adjust the outlet pressure from said pressure regulator.

8. The device according to claim 6, wherein said self-regulating means comprise at least one pressure regulator intercepting said feed line and intended to receive, in inlet, gas and/or liquid from said tank at an inlet pressure and to deliver it towards said container at an adjusted or adjustable outlet pressure and wherein said self-regulating means comprise a branch duct extended between said feed line and said pressure regulator and intended to operate on said pressure regulator so as to vary said outlet pressure.

9. The device according to claim 5, wherein said self-regulating means comprise sensor means intended to detect the pressure or the fill level in said container or the distance from the ground of a wheel placed on said container, as well as an electronic or pneumatic controller in communication with said sensor means and intended to adjust the delivery of liquid or gas through said feed line and towards said container as a function of the detection made by said sensor means.

10. The device according to claim 4, wherein said tank comprises a bomb full of gas and/or liquid or a tire of a wheel set on said abutment surface.

11. The device according to claim 1, wherein said container comprises at least one upper, in use, surface, deformable as a function of the weight applied thereto by a respective wheel and thus to be deformed and adapted complementary to a lower portion of the tread of the tire of said wheel.

12. The device according to claim 11, wherein said container comprises a first wall or base wall intended to be set on a support surface, a second wall or top wall intended to come into contact with a lower portion of a tired wheel of a vehicle and an edge wall, said edge wall extended between and sealingly connecting said first wall and said second wall.

13. The device according to claim 12, wherein said container has a fluid-sealed body configured as a geometric solid, said first wall being substantially flat or slightly curved, said edge wall being substantially tubular, while said second wall is substantially flat or slightly curved.

14. The device according to claim 13, wherein said tubular edge wall has a first lower, in use, tubular section with cross section increasing in moving away from said first wall and a second upper, in use, tubular section with cross section decreasing in moving closer to said second wall.

15. The device according to claim 13, wherein said tubular edge wall has a first lower, in use, tubular section with cross section increasing in moving away from said first wall and a second upper, in use, tubular section with cross section decreasing in moving closer to said second wall and wherein said first section and said second section of said edge wall are formed in a single piece or by means of two plates sealingly welded together in a manner so as to form a continuous curved portion with substantially constant curvature radius.

16. The device according to claim 13, wherein said second wall or top wall is movable between a rest position and a work position in which said second wall is deformed so as to delimit a curved seat or depression with concavity directed upward and having a shape substantially complementary to a lower portion of the tread of the tire of said tired wheel.

17. The device according to claim 1, further comprising a fender component connectable to a wheel and comprising a curved internal face complementary to a portion of the tread of the tire of a wheel and intended to engage said portion.

18. The device according to claim 17, wherein said fender component comprises a body with substantially U-shaped cross section with a curved intermediate section delimiting said curved internal face and two lateral sections extended from said intermediate section, one opposite to the other with respect to said intermediate section and each intended to wind around a section of a respective sidewall of a tired wheel.

19. The device according to claim 1, further comprising at least one ramp or abutment component in which at least one slot or depression is formed in which a lower portion of a wheel of a vehicle is housable, and having profile substantially complementary to said lower portion.

20. The device according to claim 1, further comprising at least one deformed or deformable wall so as to delimit a curved seat or depression with concavity directed upward and having a shape substantially complementary to a lower portion of the tread of the tire of said tired wheel, said depression or seat constituting an intermediate zone that is lowered and proximal to said first wall.

21. The device according to claim 20, wherein said intermediate zone has a length and a width, by length it being intended the extension of said intermediate zone along a first extension axis or longitudinal extension axis (z-z) of the device, while by width it is intended the extension of said intermediate zone along a second extension axis (w-w) transverse or orthogonal to said first extension axis (z-z), said intermediate zone having a substantially circular profile in section taken along a first vertical plane passing through said first extension axis (z-z) or in section taken along a plane parallel to said first vertical plane, said substantially circular profile having a concavity that during use is directed upward and having distance from said first wall increasing from the center towards the exterior of said intermediate zone, said substantially circular profile extended for the entire width of the intermediate zone, so as to configure a band with substantially circular profile.

22. The device according to claim 21, wherein said intermediate zone in section taken along a second vertical plane passing through the second extension axis (w-w), or in section taken along a plane parallel to said second vertical plane, is substantially flat at the center and for the entire or for most of the extension thereof.

23. The device according to claim 22, wherein said intermediate zone has a substantially flat cross section for the entire length thereof.

24. The device according to claim 22, wherein said intermediate zone, in section taken along a second vertical plane passing through the second extension axis (w-w) or in section taken along a plane parallel to such second vertical plane (w-w), has slightly curved external portions, the curved external portions therefore having a distance from said first wall which increases in the direction moving away from the substantially flat portion.

25. A parked vehicle provided with a frame mounted on a plurality of wheels as well as with at least one device according to any one of the preceding claims, characterized in that a lower portion of the tread of the tire of at least one wheel of said plurality of wheels is complementary with, entirely housed in and supported by an abutment surface of said at least one device so as to prevent or reduce the flattening of said at least one wheel of said parked vehicle.

26. The vehicle according to claim 25, further comprising a plurality of devices according to any one of the preceding claims, a lower portion of the tread of the tire of each wheel of said plurality of wheels being set on and complementary with an abutment surface of a respective device so as to prevent or reduce the flattening of all the wheels of said parked vehicle.

27. A method for preventing or reducing the flattening of the tire of a wheel of a vehicle during a period of parking or stopping thereof, comprising the following steps:
arranging a device for preventing or reducing the flattening of the tire of a wheel of a vehicle during a period of parking or stopping thereof, further comprising an abutment surface configured or configurable as a lower portion of the tread of a tire of a tired wheel and such to apply to said lower portion, and over the entire extension thereof, a substantially uniform pressure so as to prevent or reduce the flattening of the tire of said wheel during said parking or stopping period;
bringing at least one wheel of said vehicle on top of said at least one device such that a lower portion of the tread of the tire of said at least one wheel is entirely set on and complementary with an abutment surface of said at least one device and such to apply to said lower portion, and over the entire extension thereof, a substantially uniform pressure so as to prevent or reduce the flattening of said tire of said at least one wheel during said parking or stopping period.

28. The method according to claim 27, further comprising a step of arranging a plurality of devices according to claim 1, and in that a lower portion of the tread of the tire of each wheel of said plurality of wheels is set on and complementary with an abutment surface of a respective device so as to prevent or reduce the flattening of the tire of all the wheels of said parked vehicle.

29. The method according to claim 27, wherein it is carried out by means of at least one device according to claim 3 and in that said at least one wheel is brought on top of said device that is deflated, and then said device is inflated or filled with gas and/or liquid.

30. The method according to claim 27, wherein it is carried out by means of at least one device according to claim 3 and in that said at least one wheel is brought on top of said device already inflated or filled with gas and/or liquid.

31. The method according to claim 29, wherein it is carried out by means of at least one device according to claim 4 and in that once said container is inflated, the following steps are provided:
connecting or maintaining said container of said device connected to a tank of gas and/or liquid by means of a feed line;
when the pressure in said container falls below a threshold value, said self-regulating means cause the opening or increase of the fluid communication between said container and said tank, thus bringing the pressure or filling of said container back to the threshold value or above the threshold value.
